(19) United States
(12) Patent Application Publication
(10) Pub. No.: US 2011/0300408 A1
(43) Pub. Date: Dec. 8, 2011

(54) METHOD AND DEVICE FOR PRODUCING LOW-WEAR HARD COATINGS

(75) Inventor: René Hotz, Olten (CH)

(73) Assignee: INITONEM AG, Schlieren (CH)

(21) Appl. No.: 13/124,545

(22) PCT Filed: Oct. 16, 2009
(86) PCT No.: PCT/EP2009/007420

§ 371 Date: Aug. 12, 2011

(30) Foreign Application Priority Data
Oct. 17, 2008 (CH) 1631/08

(51) Int. Cl. B32B 15/04; C25D 3/12; C25D 15/00

(52) U.S. Cl. 428/680; 205/109; 204/273

(57) ABSTRACT

The present application relates to a method and to a device for producing a low-wear nickel and boron-containing hard coating on a metal surface. In the method according to the invention, boron or boron compound particles are dispersed in a nickel-containing electrolyte by way of gases flowing through the electrolyte. The gas flows through a liquid impermeable but gas permeable area of the container floor into the electrolytes and disperses the particles present in the electrolytes.

### CROSS-REFERENCE TO RELATED APPLICATIONS

This application is a U.S. National Stage of International Application No. PCT/EP2009/007420, filed Oct. 16, 2009, and published in the German language as WO 2010/043402 A1 on Apr. 22, 2010. This application claims priority to Swiss Application No. CH-1631/08, filed Oct. 17, 2008. The disclosure(s) of the above applications are incorporated herein by reference.

### BACKGROUND

This section provides background information related to the present disclosure which is not necessarily prior art.

### Technical Field

The present invention relates to a method and device for producing low-wear nickel- and boron-containing hard coatings on metal surfaces. The invention also relates to such hard coatings.

The coating of tribologically and otherwise mechanically highly stressed metal surfaces with hard coatings is known in various forms in prior art. Established methods for producing hard coatings on metal surfaces are PVD (physical vapor deposition), CVD (chemical vapor deposition), build-up welding, flame spraying and also electroplating with hard metals or hard metal alloys.

### Discussion

These methods are used in the domain of engine technology and here e.g. in the field of mechanically highly stressed components such as valves, valve shafts, cam shafts etc. Additional fields of application are among others the fields of hydraulic engineering or the field of printing industry where pistons or printing rollers are required to have low-wear surfaces in order to have a service life which is as long as possible.

The methods for producing hard coatings on metal surfaces known in prior art have disadvantages. Methods such as CVD, flame spraying or build-up welding usually allow only simple geometric forms and relatively small components to be hard-coated. The known electroplating methods do frequently not produce a sufficient hardness of the deposited layer.

GB 1 236 954 A discloses an electrolyte bath with solid components that are moved by way of a gas stream relative to the surface to be coated. The gas stream is blown under pressure into the basin through a nozzle. For the purpose of distribution, the gas stream is passed through a filter made of sintered metal for example.

WO 2008/101550 A1 discloses the introduction of a gas stream or a fluid stream into an electrolyte in which also solid components are contained, in order to move the components relative to a roller surface to be coated. The depositing speed is controlled by the rotation of the roller to be coated.

U.S. Pat. No. 3,081,239 discloses the introduction of pressurized air into an electrolyte bath via a passage system which is provided with nozzles.

DE 22 47 956 discloses an electrolytic nickel bath containing 50-500 g/l of powdered ceramics. Compressed air is introduced into the bath through a perforated pipe.

### SUMMARY OF THE INVENTION

It is therefore, an object of the present invention to provide a method for producing a hard coating on a metal surface with improved properties compared to methods known in prior art. It also is an object of the invention to provide a device for carrying out such a method.

According to the invention, the boron or boron compound particles present in the electrolyte are kept dispersed during the coating process and are prevented from depositing. Advantageously, the boron or boron compound particles are kept dispersed by way of a gas flowing through the electrolyte. Here, the gas flows through the electrolyte substantially against the force of gravity.

Advantageously, in the method according to the invention, the gas flowing through the electrolyte at least is one gas from the group consisting of nitrogen, oxygen, helium, neon, argon, carbon dioxide, hydrogen or a mixture thereof. In one embodiment of the method of the invention air is used as the gas.

The method according to the invention is carried out in a container in which the gas flows from the container floor through the electrolyte to the electrolyte surface. Advantageously, the container floor is at least partially impermeable to liquids but permeable to gas, and the gas flows through the area of the liquid impermeable but gas permeable container floor into the electrolyte. In one embodiment of the method the liquid impermeable but gas permeable area of the container floor is formed by a diaphragm or a membrane.

The system according to the invention has the advantage that the liquid impermeable but gas permeable membrane forming the container floor is capable of producing a spacious stream of gas bubbles, so that the dispersed substance is maintained throughout the volume of the electrolyte, while deposits on the floor are not possible. In addition, a deposition control is possible by way of an external pressure generation.

### DESCRIPTION OF THE PREFERRED EMBODIMENTS

According to the invention, adjusting the gas pressure on the side of the liquid impermeable but gas permeable area of the container floor opposite to the electrolyte allows adjusting the result of the coating. By changing the gas pressure the amount of the gas flowing through the electrolyte is changed, and due to the liquid impermeable but gas permeable area of the container floor being designed as a diaphragm or membrane, the gas flows through the electrolyte in the form of fine bubbles. Thus the degree of dispersion of the particles present in the electrolyte can be adjusted.

It is known that during the electrolysis particle separations occur in the region of the anode, and these particle separations produce the so-called anode sludge. In prior art it is known to arrange a kind of bag around the anode in order to collect and prevent the anode sludge from becoming distributed in the electrolyte. However, the problem exists that this anode bag is not impermeable to dispersed substances. Thus the anode becomes clogged over time and has an irregular distribution of the dispersed substance over the full height. The invention contributes to the technical solution by the anode being surrounded by a membrane that is permeable to ions and impermeable to sludge and dispersed substances. Within the scope of the invention, the term membrane in this context is understood to be a cover from a material which is impermeable or permeable to the respective substance and in the respective direction.

This guarantees that the dispersed substance cannot clog the anode, and the further construction according to the invention provides for an equal distribution of the dispersed substances over the full height of the electrolyte bath. The property of the dispersed substance to dock to the metal ions on the anode side is made possible by the conditioning, i.e. the conductivity.

There are no limitations concerning the temperature range, the nickel concentration, the boron and boron compound concentration, the particle size of the boron and boron compound particles dispersed in the electrolyte, the pH and the applied deposition voltage. The voltage can be applied as a DC voltage, pulse voltage or reverse pulse voltage. The usual ranges of these parameters are within the scope of the invention.

On part of the device, the object of the patent is achieved by a container for receiving the electrolyte which is characterized in that the container floor is at least partially liquid impermeable but gas permeable.

The liquid impermeable but gas permeable area of the container floor is advantageously formed by a diaphragm or a membrane.

The device according to the invention comprises a means for gas pressure regulation on the side of the liquid impermeable but gas permeable area of the container floor opposite the electrolyte.

The method and the device according to the invention enable the deposition of nickel- and boron-containing hard coatings on metal surfaces.

The coatings deposited using the method and the device according to the invention can contain further components in addition to nickel and boron. These components are at least one element from the group consisting of titanium, chromium, vanadium, manganese, molybdenum, magnesium, cobalt, copper, zinc, niobium, tungsten, tin, aluminum, silicium, phosphorus, carbon or nitrogen or a combination of these elements.

1.-15. (canceled)

16. A method for producing a low-wear nickel- and boron-containing hard coating on a metal surface, comprising:
wherein the metal surface to be coated is contacted with a nickel-containing electrolyte in the form of a dispersion bath containing boron or boron compound particles, while applying a deposition voltage, wherein during the coating process the boron or boron compound particles contained in the electrolyte are kept dispersed by way of a gas flowing through the electrolyte and are prevented from settling, wherein the method is carried out in a container in which the gas flows from the container floor through the electrolyte to the electrolyte surface, wherein the container floor is at least partially liquid impermeable but gas permeable and wherein the gas flows through the liquid impermeable but gas permeable area of the container floor to the electrolyte.

17. The method according to claim 16, wherein the gas flowing through the electrolyte, flows through the electrolyte substantially against the force of gravity.

18. The method according to claim 16, wherein the gas flowing through the electrolyte is at least one gas from the group consisting of nitrogen, oxygen, helium, neon, argon, carbon dioxide, hydrogen or a mixture thereof.

19. The method according to claim 16, wherein the liquid impermeable but gas permeable area of the container floor is formed by a diaphragm or a membrane.

20. The method according to claim 16, wherein the gas pressure is adjusted on the side of the liquid impermeable but gas permeable area of the container floor opposite the electrolyte and in dependence of the desired result of the coating.

21. The method according to claim 16, wherein the method is carried out using a voltage source selected from the group of a DC voltage, a pulse voltage or a reverse pulse voltage.

22. The method according to claim 16, wherein the voltage source includes an anode ishielded by a membrane that is open to ions and impermeable to sludge and dispersed substances.

23. A device for carrying out the method according to claim 16 and comprising a container for receiving the electrolyte, wherein the container floor is at least partially liquid impermeable but gas permeable.

24. The device according to claim 23, wherein the liquid impermeable but gas permeable part of the container floor is formed by a diaphragm or a membrane.

25. The device according to claim 23, wherein the device comprises means for regulating the gas pressure on the side of the liquid impermeable but gas permeable area of the container floor opposite the electrolyte.

26. The device according to claim 23, wherein an anode of a voltage source is shielded by a membrane that is open to ions and impermeable to sludge and dispersed substances.

27. A hard coating produced by a method according to claim 16, wherein the coating includes further components in addition to nickel and boron.

28. The hard coating according to claim 27, wherein the hard coating includes as additional components at least one element from the group consisting of Ti, Cr, V, Mn, Mo, Mg, Co, Cu, Zn, Nb, W, Sn, Al, Si, P, C, N or a compound thereof.
